(19) United States
(12) Patent Application Publication
(10) Pub. No.: US 2022/0214185 A1
(43) Pub. Date: Jul. 7, 2022

(54) SYSTEMS AND METHODS FOR RECOMMENDATION AND DISPLAY OF POINT OF INTEREST

(71) Applicant: BEIJING DIDI INFINITY TECHNOLOGY AND DEVELOPMENT CO., LTD., Beijing (CN)

(72) Inventors: Ting XIONG, Beijng (CN); Yue LIU, Beijng (CN); Wangting CHEN, Beijng (CN)

(73) Assignee: BEIJING DIDI INFINITY TECHNOLOGY AND DEVELOPMENT CO., LTD., Beijing (CN)

(21) Appl. No.: 17/656,419

(22) Filed: Mar. 24, 2022

Related U.S. Application Data
(63) Continuation of application No. PCT/CN2019/107798, filed on Sep. 25, 2019.

(51) Int. Cl. G01C 21/36; G01C 21/34

(52) U.S. Cl. CPC G01C 21/3682; G01C 21/3415; G01C 21/3476

(57) ABSTRACT

The present disclosure provides systems and methods for recommendation and display of point of interest (POI). The method may include obtaining an initial point of interest (POI) of a user. The method may also include determining whether the initial POI is an area of interest (AOI) and in response to a determination that the initial POI is the AOI, generating a planar area describing the AOI. The planar area may include one or more candidate POIs. The method may also include determine, based at least on one of the initial POI or a current location of the user, a recommended POI from the one or more candidate POIs and displaying the planar area with the recommended POI to the user.

### CROSS-REFERENCE TO RELATED APPLICATIONS

This application is a continuation of International Application No. PCT/CN2019/107798, filed on Sep. 25, 2019, the contents of which are hereby incorporated by reference.

### TECHNICAL FIELD

The present disclosure generally relates to interface display technology, and in particular, to systems and methods for point of interest recommendation and display.

### BACKGROUND

Online to offline services utilizing Internet technology have become increasingly popular. Taking an online transportation service (e.g., taxi hailing services) as an example, in some cases, a user can initiate a service request by inputting an initial point of interest (POI) via a user terminal. After receiving the service request, a system providing the online transport service can determine one or more recommended locations associated with the initial POI and display the recommend locations on a map to the user. However, when the initial POI is an area of interest (AOI), it can be difficult for the user to identify the recommended locations from the map quickly and accurately. Therefore, it is desirable to provide systems and methods for assisting a user in identifying a POI accurately and efficiently.

### SUMMARY

According to a first aspect of the present disclosure, a system for recommendation and display of a point of interest (POI) is provided. The system may include at least one storage medium and at least one processor in communication with the at least one storage medium. The at least one storage medium may include a set of instructions. When executing the set of instructions, the system may be configured to perform one or more of the following operations. The system may obtain an initial point of interest (POI) of a user. The system may determine whether the initial POI is an area of interest (AOI). In response to a determination that the initial POI is an AOI, the system may generate a planar area describing the AOI. The planar area may include one or more candidate POIs. The system may determine, based at least on one of the initial POI or a current location of the user, a recommended POI from the one or more candidate POIs. The system may display the planar area with the recommended POI to the user.

In some embodiments, to display the planar area with the recommended POI to the user, the system may be configured to perform one or more of the following operations. The system may mark a location of the recommended POI on the planar area of the AOI using an identifier. The system may direct a client terminal of the user to display the planar area of the AOI with the identifier to the user on a map.

In some embodiments, in response to receipt of a signal indicating that the user accepts the recommended POI, the system may generate a route with the recommended POI as a destination and the current location of the user as a starting location. The system may display the route on the map.

In some embodiments, in response to the receipt of a signal indicating that the user moves the identifier, the system may determine a corrected POI based on a location that the moved identifier points to. The system may generate a route with the corrected POI as the destination and the current location of the user as the starting location. The system may display the route on the map.

In some embodiments, the route may be a walking navigation path with a nearest distance between the destination and the current location of the user.

In some embodiments, the system may display one or more reference POIs close to the destination on the map to help the user to identify the location of the destination.

In some embodiments, to determine, based at least on one of the initial POI or the current location of the user, the recommended POI from the one or more candidate POIs, the system may be configured to perform one or more of the following operations.

The system may rank, based on one or more features of each of the one or more candidate POIs, the one or more candidate POIs to obtain a ranking result of the one or more candidate POIs. The system may determine the recommended POI based on the ranking result.

In some embodiments, the ranking of the one or more candidate POIs may be performed using a LambdaMART model.

In some embodiments, the one or more features of each of the one or more candidate POIs may include at least one of a hotness of each of the one or more candidate POIs, a distance between the initial POI and the each of the one or more candidate POIs, and a distance between the current location of the user and the each of the one or more candidate POIs.

In some embodiments, to obtain an initial point of interest (POI) of a user, in response to an operation instruction to move a map by the user, the system may determine the initial POI.

In some embodiments, in response to a determination that the initial POI is not the AOI, the system may generate the recommended POI based on at least one of the initial POI or the current location of the user. The system may display the recommended POI to the user.

According to a second aspect of the present disclosure, a method for recommendation and display of a point of interest (POI) is provided. The method may be implemented on at least one computing device, each of which may include at least one processor and a storage device. The method may include one or more of the following operations. The method may include obtaining an initial point of interest (POI) of a user. The method may include determining whether the initial POI is an area of interest (AOI). In response to a determination that the initial POI is the AOI, the method may include generating a planar area describing the AOI, the planar area including one or more candidate POIs. The method may include determining, based at least on one of the initial POI or a current location of the user, a recommended POI from the one or more candidate POIs. The method may include displaying the planar area with the recommended POI to the user.

According to a third aspect of the present disclosure, a system for point of interest (POI) recommendation and display is provided. The system may include an obtaining module, a determination module, and a displaying module. The obtaining module may be configured to obtain an initial point of interest (POI) of a user. The determination module may be configured to determine whether the initial POI is an area of interest (AOI). In response to a determination that the initial POI is the AOI, the determination module may be configured to generate a planar area describing the AOI. The planar area may include one or more candidate POIs. The determination module may determine, based at least on one of the initial POI or a current location of the user, a recommended POI from the one or more candidate POIs. The displaying module may be configured to display the planar area with the recommended POI to the user.

According to a fourth aspect of the present disclosure, a non-transitory computer readable medium may store instructions, the instructions, when executed by at least one processor, the at least one processor may be configured to perform one or more of the following operations. The at least one processor may obtain an initial point of interest (POI) of a user. The at least one processor may determine whether the initial POI is an area of interest (AOI). In response to a determination that the initial POI is an AOI, the at least one processor may generate a planar area describing the AOI. The planar area may include one or more candidate POIs. The at least one processor may determine, based at least on one of the initial POI or a current location of the user, a recommended POI from the one or more candidate POIs. The at least one processor may display the planar area with the recommended POI to the user.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary online to offline service system according to some embodiments of the present disclosure;

FIG. 2 is a schematic diagram illustrating hardware and/or software components of an exemplary computing device according to some embodiments of the present disclosure;

FIG. 3 is a schematic diagram illustrating hardware and/or software components of an exemplary mobile device according to some embodiments of the present disclosure;

FIG. 4 is a block diagram illustrating an exemplary processing device according to some embodiments of the present disclosure;

FIG. 5 is a schematic flowchart illustrating an exemplary process for point of interest recommendation and display according to some embodiments of the present disclosure;

FIG. 6 is a schematic flowchart illustrating an exemplary process for point of interest recommendation and display according to some embodiments of the present disclosure;

FIG. 7 is a schematic flowchart illustrating an exemplary process for determining a recommended point of interest according to some embodiments of the present disclosure; and

FIG. 8 is a schematic diagram illustrating an exemplary user display interface of a client terminal according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes” and/or “including” when used in this disclosure, specify the presence of stated features, integers, steps, operations, elements, and/or components, but do not preclude the presence or addition of one or more other features, integers, steps, operations, elements, components, and/or groups thereof.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Embodiments of the present disclosure may be applied to different transportation systems including but not limited to land transportation, sea transportation, air transportation, space transportation, or the like, or any combination thereof. A vehicle of the transportation systems may include a rickshaw, travel tool, taxi, chauffeured car, hitch, bus, rail transportation (e.g., a train, a bullet train, high-speed rail, and subway), ship, airplane, spaceship, hot-air balloon, driverless vehicle, or the like, or any combination thereof. The transportation system may also include any transportation system that applies management and/or distribution, for example, a system for sending and/or receiving an express.

Some embodiments of the present disclosure relate to systems and methods for point of interest (POI) recommendation and display. A method may include obtaining an initial point of interest (POI) of a user. The method may include determining whether the initial POI is an area of interest (AOI). In response to a determination that the initial POI is the AOI, the method may also include generating a planar area describing the AOI. The planar area may include one or more candidate POIs. The method may also include determining a recommended POI from the one or more candidate POIs based at least on one of the initial POI or a current location of the user. The method may also include displaying the planar area with the recommended POI to the user. In some embodiments, the method may mark a location of the recommended POI on the planar area of the AOI using an identifier. According to the present disclosure, the recommended POI may be displayed on a map with the planar area, which may help the user to know the location of the recommended POI on the map and a relationship between the current location of the user and the recommended POI. Further, the user may quickly and accuracy find the recommended POI based on the identifier on the map and the relationship between the current location of the user and the recommended POI.

The application scenarios of different embodiments of the present disclosure may include but not limited to an online to offline service system, a driving system (e.g., an automatic pilot system), a map and/or navigation system, or the like, or a combination thereof. For example, taking an online to offline system as an example, an online to offline service platform may receive a service request from a mobile terminal of a user. A POI recommendation system may determine a target POI for picking up the user based on information associated with the service request as described elsewhere in the present disclosure. It should be understood that application scenarios of the system and method disclosed herein are only some examples or embodiments. Those having ordinary skills in the art, without further creative efforts, may apply these drawings to other application scenarios, for example, another similar server.

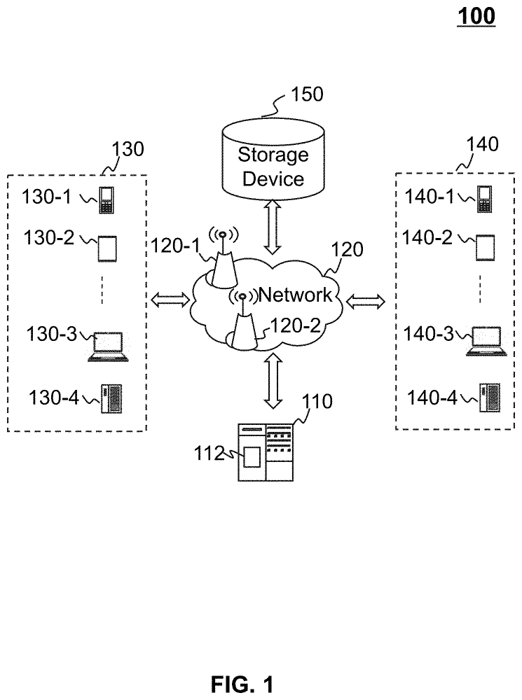

FIG. 1 is a schematic diagram illustrating an exemplary online to offline service system according to some embodiments of the present disclosure. In some embodiments, the online to offline service system may be a system for online to offline services. For example, the online to offline service system 100 may be an online transportation service platform for transportation services such as taxi hailing, chauffeur services, delivery vehicles, express car, carpool, bus service, driver hiring, shuttle services, etc. The online to offline service system 100 may include a server 110, a network 120, a requester terminal 130, a provider terminal 140, and a storage device 150.

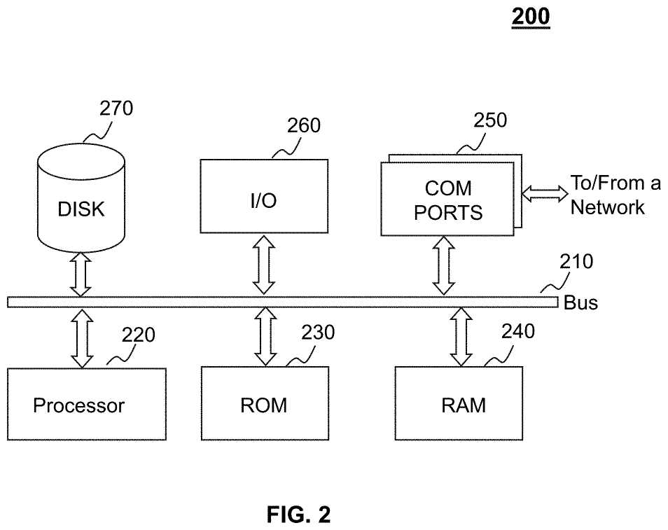

In some embodiments, the server 110 may be a single server or a server group. The server group may be centralized or distributed (e.g., server 110 may be a distributed system). In some embodiments, the server 110 may be local or remote. For example, the server 110 may access information and/or data stored in the requester terminal 130, the provider terminal 140, and/or the storage device 150 via the network 120. As another example, the server 110 may be directly connected to the requester terminal 130, the provider terminal 140, and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 including one or more components illustrated in FIG. 2.

In some embodiments, the server 110 may include a processing device 112. The processing device 112 may process information and/or data relating to a service request to perform one or more functions described in the present disclosure. For example, the processing device 112 may obtain an initial point of interest of a user from the requester terminal 130 or the provider terminal 140 via the network 120. As another example, the processing device 112 may determine whether the initial POI is an area of area (AOI). As still another example, the processing device 112 may generate a planar area describing the AOI. The planar area may include one or more candidate POIs. As still another example, the processing device 112 may determine a recommended POI from the one or more candidate POIs and display the planar area with the recommended POI to the user. In some embodiments, the processing device 112 may initiate a service request based on the recommended POI in response to the receipt of a signal indicating that the user receives the recommended POI. For example, for an online transport service, the processing device 112 may designate the recommended POI as a pickup location of the user for a service provider picking up the user. In some embodiments, the processing device 112 may include one or more processing engines (e.g., single-core processing engine(s) or multi-core processor(s)). The processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof. In some embodiments, the processing device 112 may be integrated in the requester terminal 130 or the provider terminal 140.

The network 120 may facilitate exchange of information and/or data. In some embodiments, one or more components (e.g., the server 110, the requester terminal 130, the provider terminal 140, or the storage device 150) of the online to offline service system 100 may transmit information and/or data to other component(s) of the online to offline service system 100 via the network 120. For example, the server 110 may obtain a service request from the requester terminal 130 via the network 120. In some embodiments, the network 120 may be any type of wired or wireless network, or any combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the online to offline service system 100 may be connected to the network 120 to exchange data and/or information.

In some embodiments, a service requester may be a user of the requester terminal 130. In some embodiments, the user of the requester terminal 130 may be someone other than the service requester. For example, a user A of the requester terminal 130 may use the requester terminal 130 to send a service request for a user B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a user D, and/or information or instructions from the server 110.

In some embodiments, the requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include an onboard computer, an onboard television, etc. In some embodiments, the requester terminal 130 may be a device with positioning technology for locating the location of the service requester and/or the requester terminal 130.

In some embodiments, the provider terminal 140 may be similar to, or the same device as the requester terminal 130. In some embodiments, the provider terminal 140 may be a device with positioning technology for locating the location of the service provider and/or the provider terminal 140. In some embodiments, the requester terminal 130 and/or the provider terminal 140 may communicate with other positioning devices to determine the location of the service requester, the requester terminal 130, the service provider, and/or the provider terminal 140. In some embodiments, the requester terminal 130 and/or the provider terminal 140 may send positioning information to the server 110.

In some embodiments, the requester terminal 130 and/or the provider terminal 140 may be a client terminal. The client terminal may send and/or receive information for object detection to the processing device 112 via a user interface. The user interface may be in the form of an application for the online to offline service system 100 implemented on the requester terminal 130 and/or the provider terminal 140. The user interface implemented on the requester terminal 130 and/or the provider terminal 140 may be configured to facilitate communication between users of the requester terminal 130 and/or the provider terminal 140, and the processing device 112. For example, a service requester may send a service request to the processing device 112 via the user interface of the requester terminal 130. As another example, the service requester may input a starting location and/or destination via the user interface of the requester terminal 130.

The storage device 150 may store data and/or instructions relating to the service request. In some embodiments, the storage device 150 may store data obtained from the requester terminal 130 and/or the provider terminal 140. In some embodiments, the storage device 150 may store data and/or instructions that the server 110 may execute or use to perform exemplary methods described in the present disclosure. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components (e.g., the server 110, the requester terminal 130, the provider terminal 140) of the online to offline service system 100. One or more components of the online to offline service system 100 may access the data and/or instructions stored in the storage device 150 via the network 120. In some embodiments, the storage device 150 may be directly connected to or communicate with one or more components (e.g., the server 110, the requester terminal 130, the provider terminal 140) of the online to offline service system 100. In some embodiments, the storage device 150 may be part of the server 110.

In some embodiments, one or more components (e.g., the server 110, the requester terminal 130, the provider terminal 140) of the online to offline service system 100 may have permissions to access the storage device 150. In some embodiments, one or more components of the online to offline service system 100 may read and/or modify information relating to the service requester, the service provider, and/or the public when one or more conditions are met. For example, the server 110 may read and/or modify one or more service requesters' information after a service is completed. As another example, the provider terminal 140 may access information relating to the service requester when receiving a service request from the requester terminal 130, but the provider terminal 140 may not modify the relevant information of the service requester.

In some embodiments, information exchanging of one or more components of the online to offline service system 100 may be achieved by way of requesting a service. The object of the service request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

One of ordinary skill in the art would understand that when an element (or component) of the online to offline service system 100 performs, the element may perform through electrical signals and/or electromagnetic signals. For example, when the requester terminal 130 transmits out a service request to the server 110, a processor of the requester terminal 130 may generate an electrical signal encoding the request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, the provider terminal 140 may process a task through operation of logic circuits in its processor, and receive an instruction and/or a service request from the server 110 via electrical signals or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium (e.g., the storage device 150), it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of a computing device 200 on which the server 110, the requester terminal 130 and/or the provider terminal 140 may be implemented according to some embodiments of the present disclosure. For example, the processing device 112 may be implemented on the computing device 200 and configured to perform functions of the processing device 112 disclosed in this disclosure.

The computing device 200 may be a special purpose computer in some embodiments. The computing device 200 may be used to implement the online to offline service system 100 for the present disclosure. The computing device 200 may implement any component that performs one or more functions disclosed in the present disclosure. In FIGS. 1-2, only one such computing device is shown purely for convenience purposes. One of ordinary skill in the art would understand that the computer functions relating to the POI recommendation as described herein may be implemented in a distributed fashion on a number of similar platforms, to distribute the processing load.

The computing device 200, may include communication ports (COM ports) 250 connected to and from a network (e.g., the network 120) connected thereto to facilitate data communications. The computing device 200 may also include a processor 220, in the form of one or more processors, for executing program instructions. The exemplary computer platform may include an internal communication bus 210, a program storage and a data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the processor 220. The methods and/or processes of the present disclosure may be implemented as the program instructions. The computing device 200 also includes an I/O component 260, supporting input/output between the computing device 200 and other components. Moreover, the computing device 200 may receive programs and data via the communication network.

Merely for illustration, only one processor 220 is described in the computing device 200. However, it should be note that the computing device 200 in the present disclosure may also include multiple processors, thus operations and/or method steps that are performed by one processor 220 as described in the present disclosure may also be jointly or separately performed by the multiple processors. For example, if in the present disclosure the processor 220 of the computing device 200 executes both operation A and operation B, it should be understood that operation A and operation B may also be performed by two different processors jointly or separately in the computing device 200 (e.g., the first processor executes operation A and the second processor executes operation B, or the first and second processors jointly execute operations A and B).

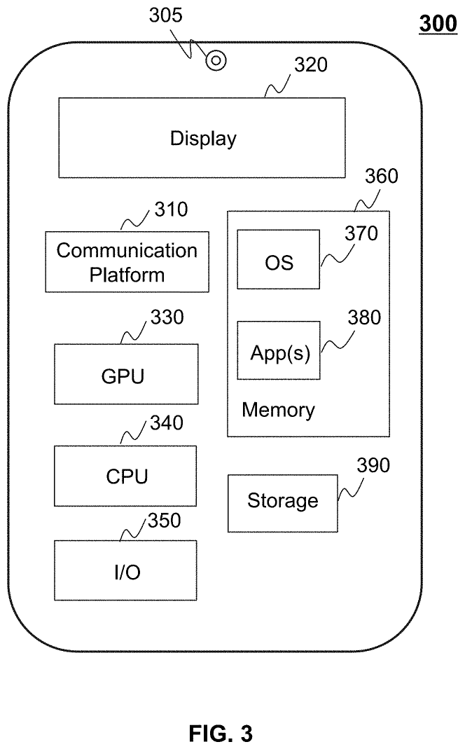

FIG. 3 is a schematic diagram illustrating exemplary hardware and/or software components of an exemplary mobile device according to some embodiments of the present disclosure. As illustrated in FIG. 3, the mobile device 300 may include a camera 305, a communication platform 310, a display 320, a graphic processing unit (GPU) 330, a central processing unit (CPU) 340, an I/O 350, a memory 360, a mobile operating system (OS) 370, application (s) 380, and a storage 390. In some embodiments, any other suitable component, including but not limited to a system bus or a controller (not shown), may also be included in the mobile device 300.

In some embodiments, the mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the online to offline service system 100. User interactions with the information stream may be achieved via the I/O 350 and provided to the storage device 150, the server 110 and/or other components of the online to offline service system 100. In some embodiments, the mobile device 300 may be an exemplary embodiment corresponding to a terminal associated with the online to offline service system 100, the requester terminal 130 and/or the provider terminal 140.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to recommend POI as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

One of ordinary skill in the art would understand that when an element of the online to offline service system 100 performs, the element may perform through electrical signals and/or electromagnetic signals. For example, when a server 110 processes a task, such as determining a recommended POI from one or more candidate POIs, the server 110 may operate logic circuits in its processor to process such task. When the server 110 completes determining a recommended POI from one or more candidate POIs, the processor of the server 110 may generate electrical signals encoding the recommended POI. The processor of the server 110 may then send the electrical signals to at least one data exchange port of a target system associated with the server 110. The server 110 communicates with the target system via a wired network, the at least one data exchange port may be physically connected to a cable, which may further transmit the electrical signals to an input port (e.g., an information exchange port) of the requester terminal 130. If the server 110 communicates with the target system via a wireless network, the at least one data exchange port of the target system may be one or more antennas, which may convert the electrical signals to electromagnetic signals. Within an electronic device, such as the requester terminal 130, the provider terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage device 150), it may send out electrical signals to a read/write device of the storage medium, which may read or write structured data in the storage medium. The structured data may be transmitted to the processor in the form of electrical signals via a bus of the electronic device. Here, an electrical signal may be one electrical signal, a series of electrical signals, and/or a plurality of discrete electrical signals.

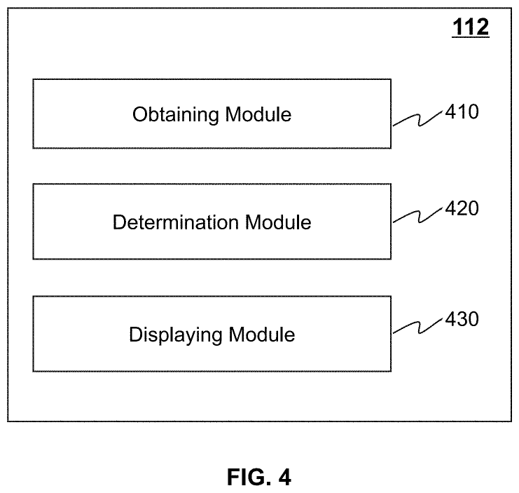

FIG. 4 is a block diagram illustrating an exemplary processing device 112 according to some embodiments of the present disclosure. The processing device 112 may include an obtaining module 410, a determination module 420, and a displaying module 430. Each of the modules described above may be a hardware circuit that is designed to perform certain actions, e.g., according to a set of instructions stored in one or more storage media, and/or any combination of the hardware circuit and the one or more storage media.

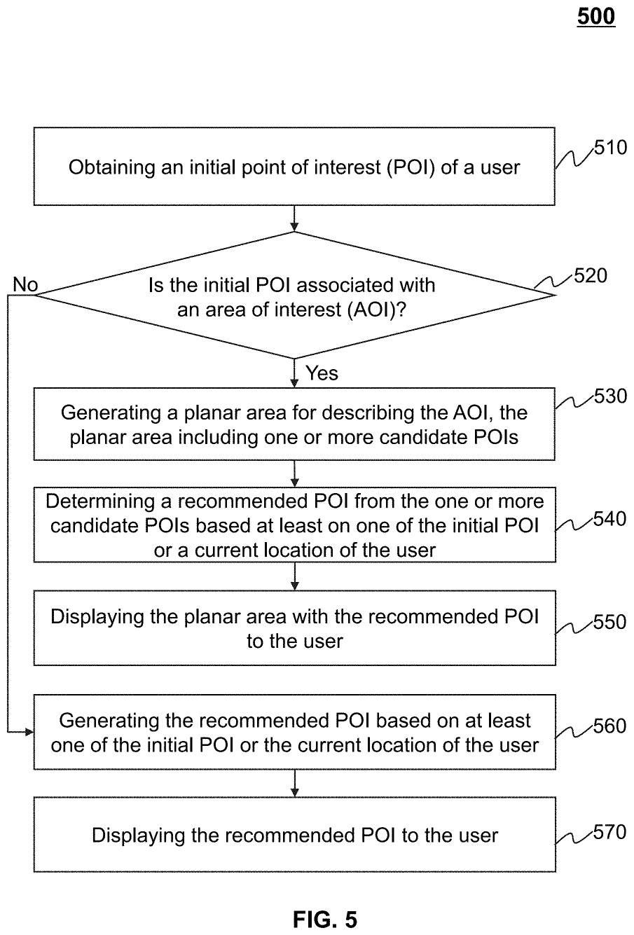

The obtaining module 410 may be configured to obtain an initial point of interest (POI) of a user. As used herein, a POI may refer to a point or region representing a location that someone may find useful or interesting. The initial POI of the user may refer to an intended or desired location of the user. For example, the initial POI may be a start location or a pickup location associated with a transportation service request of the user. In some embodiments, the initial POI of the user may represent a specific region associated with one or more region parameters (e.g., a size of the region, a shape of the region, an area of the region, a largest distance between two points on a boundary of the region, an average travel time (e.g., an average walking time) between the two points, etc.) greater than a threshold. In some embodiments, the initial POI of the user may represent a specific region associated with one or more region parameters (e.g., a size of the region, a shape of the region, an area of the region, a largest distance between two points on a boundary of the region, an average travel time (e.g., an average walking time) between the two points, etc.) smaller than a threshold. More descriptions for obtaining the initial POI may be found elsewhere in the present disclosure (e.g., FIG. 5 and the descriptions thereof).

The determination module 420 may be configured to determine whether the initial POI is associated with an area of interest (AOI). As used herein, an AOI may refer to a region associated with one or more region parameters (e.g., an area of the region, a largest distance between two points on a boundary of the region, an average travel time (e.g., an average walking time) between the two points) greater than a threshold. In some embodiments, the AOI may represent a polygonal geographical entity in map data. The polygonal geographical entity may be a residential district, a hospital, a university, a shopping mall, a scenic spot, or any other entity that can be collectively described by one name. In some embodiments, the term “AOI” may refers to information associated with an AOI, such as an AOI name, an AOI location (e.g., a location name), coordinate ranges, an AOI contour, or the like, or any combination thereof. The AOI contour may be a boundary of the AOI. As used herein, a POI associated with an AOI may refer to that the POI is the AOI, or the POI is located within the AOI geographically. A POI located within an AOI may refer to that the location of the POI is within a geographical scope of the AOI.

In some embodiments, the determination module 420 may determine whether the initial POI is associated with the AOI by determining whether the initial POI is the AOI. In some embodiments, the determination module 420 may determine whether the initial POI is the AOI based on the information of the initial POI, such as a name and/or location name of the initial POI, one or more region parameters (e.g., an area of the region, a largest distance between two points on a boundary of the region, an average travel time (e.g., an average walking time) between the two points) of the initial POI. In some embodiments, the determination module 420 may determine whether the initial POI is associated with the AOI by determining whether the initial POI is located within the AOI, geographically. For example, the determination module 420 may identify one or more AOIs from an AOI database based on information (e.g., a name, a location name) of the initial POI. Then the determination module 420 may determine whether the initial POI is located geographically within one of the one or more AOIs based on the location of the initial POI and the geographical scope of the one of the one or more AOIs. In some embodiments, the determination module 420 may determine whether the initial POI is located within one of the one or more AOIs based on a distance between the initial POI and each of the one or more AOIs.

In response to a determination that the initial POI is associated with the AOI, the determination module 420 may generate a planar area for describing the AOI. In some embodiments, the planar area may be used to enclose and describe a geographical scope of the AOI. The planar area may be an area of any shape, such as, a triangle, a quadrangle, a pentagon, a circle, an ellipse, etc. In some embodiments, the shape of the planar area may be the same as or similar to the shape of the AOI contour. In some embodiments, the planar area may be a minimum bounding box that has a preset shape (e.g., a rectangle, a square, a polygon, a circle, an ellipse) and encloses the AOI on the map. In some embodiments, the determination module 420 may determine the planar area by determining the AOI associated with the initial POI. The planar area may include one or more candidate POIs. In some embodiments, a candidate POI may be a specific location within the AOI, such as an entrance/exit, a shop, a station, or the like, or any other places. In some embodiments, the determination module 420 may determine the one or more candidate POIs based on the AOI.

In some embodiments, the determination module 420 may determine a recommended POI from the one or more candidate POIs based on at least one of the initial POI or a current location of the user. In some embodiments, the determination module 420 may determine one of the one or more candidate POIs as the recommended POI based on a location relationship between the initial POI and/or the current location of the user and each of the one or more candidate POIs. In some embodiments, the determination module 420 may determine one of the one or more candidate POIs as the recommended POI based on a hotness of each of the one or more candidate POIs. In some embodiments, the determination module 420 may determine the recommended POI from the one or more candidate POIs based on user's historical records in a past period of time (e.g., a day, a week, a month, etc.). In some embodiments, the determination module 420 may determine the recommended POI based on a ranking result of the one or more candidate POIs.

In response to a determination that the initial POI does not associated with the AOI, the determination module 420 may generate the recommended POI based on at least one of the initial POI or the current location of the use. In some embodiments, the determination module 420 may designate the initial POI or the current location of the user as the recommended POI. In some embodiments, the determination module 420 may determine one or more candidate POIs based on at least one of the initial POI or the current location of the user. Then the determination module 420 may identify the recommended POI from the one or more candidate POIs.

The displaying module 430 may be configured to display the recommended POI to the user. In some embodiments, the displaying module 430 may direct a client terminal (e.g., the requester terminal 130, the provider terminal 140) of the user to display the recommended POI. In some embodiments, the displaying module 430 may mark a location of the recommended POI using an identifier. In some embodiments, the displaying module 430 may display the information (e.g., the name, the address, coordinates (e.g., a longitude and/or a latitude), etc.) of the recommended POI next to the identifier. In some embodiments, the displaying module 430 may display the current location of the user on the map using another identifier. The identifier of the current location and the identifier of the recommended POI may be same or different.

In some embodiments, the displaying module 430 may display a location and/or direction relationship between the current location of the user and the recommended POI on the map. In some embodiments, the displaying module 430 may display a route with the recommended POI as a destination and the current location of the user as a starting location on the map in response to determine the recommended POI. In some embodiments, the displaying module 430 may display a route with the recommended POI as a destination and the current location of the user as a starting location in response to the receipt of a signal indicating that the user accepts the recommended POI. In some embodiments, the displaying module 430 may display information associated with the route between the recommended POI and the current location to the user. In some embodiments, the displaying module 430 may display one or more reference POIs close to the recommended POI and/or the current location of the user on the map to help the user to identify the recommended POI and/or the current location of the user. The one or more reference POIs may be easier to identify for the user.

In some embodiments, the displaying module 430 may be configured to display the planar area with the recommended POI to the user. In some embodiments, the displaying module 430 may display the planar area on the map for highlighting the AOI, such that the AOI may be distinguished from other regions on the map. In some embodiments, the planar area may be clearly displayed on a display (e.g., the display 320) while other regions in the map may be displayed more ambiguously. In other words, a definition of the AOI may be higher than other regions on the map. In some embodiments, the color of the planar area may be different from the color of other regions of the map.

It should be noted that the above description is merely provided for the purposes of illustration, and not intended to limit the scope of the present disclosure. Apparently, for persons having ordinary skills in the art, multiple variations and modifications may be conducted under the teachings of the present disclosure. However, those variations and modifications do not depart from the scope of the present disclosure. For example, the processing device 112 may further include an image preprocessing module (not shown in FIG. 4). The image preprocessing module may be configured to preprocess an image input by the user when the user input the initial POI via an image. As another example, the determination module 420 and the displaying module 430 may be integrated into one module.

FIG. 5 is a schematic flowchart illustrating an exemplary process for point of interest (POI) recommendation and display according to some embodiments of the present disclosure. In some embodiments, the process 500 may be implemented as a set of instructions (e.g., an application) stored in the storage device 150, ROM 230 or RAM 240, or storage 390. The processing device 112, the processor 220, and/or the CPU 340 may execute the set of instructions, and when executing the instructions, the processing device 112, the processor 220, and/or the CPU 340 may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process 500 illustrated in FIG. 5 and described below is not intended to be limiting.

In 510, the processing device 112 (e.g., the obtaining module 410) may obtain an initial point of interest (POI) of a user. As used herein, a POI may refer to a point or region representing a location that someone may find useful or interesting. The initial POI of the user may refer to an intended or desired location of the user. For example, the initial POI may be a start location or a pickup location associated with a transportation service request of the user. In some embodiments, the term “POI” refers to information associated with a POI, such as a POI name, a POI location (e.g., a location name, an address), coordinate ranges, coordinates (e.g., the longitude and latitude), one or more region parameters of the POI, or the like, or any combination thereof. The region parameters of a POI may include a size of the region, a shape of the region, an area of the region, a largest distance between two points on a boundary of the region, an average travel time (e.g., an average walking time) between the two points, etc.

In some embodiments, the initial POI of the user may represent a specific region associated with one or more region parameters (e.g., a size of the region, a shape of the region, an area of the region, a largest distance between two points on a boundary of the region, an average travel time (e.g., an average walking time) between the two points, etc.) greater than a threshold. For example, the initial POI may represent a shop, a station, a square, a building, a residential district, a parking lot, etc., with an area greater than an area threshold (e.g., 1 km², 5 km², 10 km²). In some embodiments, the initial POI of the user may represent a specific region associated with one or more region parameters (e.g., a size of the region, a shape of the region, an area of the region, a largest distance between two points on a boundary of the region, an average travel time (e.g., an average walking time) between the two points, etc.) smaller than a threshold. For example, the initial POI may represent an entrance and/or exit of a station, or of a shop, or of a square, or of a building, or of a residential district, or of a parking lot, etc., with an area smaller than an area threshold (e.g., 1 m², 5 m², 10 m²).

In some embodiments, the processing device 112 may obtain the initial POI of the user based on an input of the user. For example, the user may directly input the initial POI (e.g., at least a portion of the initial POI name) via a user interface (e.g., an online transport service application) implemented on a mobile terminal (e.g., the requester terminal 130) of the user. The mobile terminal (e.g., the requester terminal 130) may transmit the initial POI to the server 110 or the storage device 150 via the network 120. In some embodiments, the user may input the initial POI in a form of text, voice, picture or image, etc. In some embodiments, the processing device 112 may mark the initial POI on a map using an identifier (e.g., a pin, a dot, etc.) and direct the mobile terminal (e.g., the requester terminal 130) to display the map with the identifier to the user. The processing device 112 may analyze the location of the initial POI based on the location of the identifier on the map. The identifier of the initial POI may denote a rough location of the initial POI. In some embodiments, the identifier may be moved and/or dragged on the map. The user may change the initial POI by moving the identifier via the user interface. In some embodiments, the user may directly click a specific location on the map to place the identifier on the specific location to determine the initial POI. In some embodiments, the user may move the map to change the location of the identifier for changing the initial POI. For example, the user may drag the map to change the location of the identifier of the initial POI on the map. In some embodiments, the user may move the map by one or more buttons. For example, the user may move the map by pressing or clicking the one or more buttons (e.g., a button for up, a button for down, a button for left, a button for right, etc.) that can be used to move the map. In some embodiments, the processing device 112 may determine a recommendation list having a plurality of candidate initial POIs based on the user input. For example, the processing device 112 may determine a prefix, a key term, a phrase, etc., based on the user input and determine the plurality of candidate initial POIs including the prefix, the key term, the phrase, etc. The processing device 112 may determine the initial POI based on the recommendation list. For example, the processing device 112 may designate one of the plurality of candidate initial POIs as the initial POI. As another example, the processing device 112 may transmit the recommendation list to a mobile terminal of the user and direct the mobile terminal to display the plurality of candidate initial POIs to the user. The user may choose the initial POI from the plurality of candidate initial POIs in the recommendation list. The processing device 112 may determine the initial POI based on the choice of the user. In some embodiments, the processing device 112 may determine the initial POI based on a current location of the user. For example, the processing device 112 may determine the initial POI by analyzing the current location of the user. The current location may be located within the initial POI or with a certain range from the initial POI. As another example, the processing device 112 may determine the current location of the user as the initial POI. As another example, the processing device 112 may determine one or more candidate initial POIs at least in part based on the current location of the user. The processing device 112 may transmit the one or more candidate initial POIs to a mobile terminal of the user and direct the mobile terminal to display the one or more candidate initial POIs to the user. The user may determine one of the one or more candidate initial POIs as the initial POI. The current location of the user may refer to a geographical position of the user or the mobile terminal of the user. The current location of the user may be determined based on a positioning device (e.g., a GPS device) installed in the mobile terminal of the user.

In 520, the processing device 112 (e.g., determination module 420) may determine whether the initial POI is associated with an area of interest (AOI). In response to a determination that the initial POI is associated with the AOI, the processing device 112 may proceed to perform operation 530. In response to a determination that the initial POI is not associated with the AOI, the processing device 112 may proceed to perform operation 560.

As used herein, an AOI may refer to a region associated with one or more region parameters (e.g., an area of the region, a largest distance between two points on a boundary of the region, an average travel time (e.g., an average walking time) between the two points) greater than a threshold. For example, a region with an area greater than an area threshold (e.g., 1 km², 5 km², 10 km², 20 km²) may be designated as an AOI. As another example, it is assumed that a region is a rectangle region and a diagonal distance of the region is larger than a distance threshold (e.g., 1 km, 2 km, 5 km, 10 km, etc.), the region may be designated as an AOI. As a further example, it is assumed that a region is a rectangle region and an average walking time along a diagonal line of the region is greater than a time threshold (e.g., 10 minutes, 20 minutes, 30 minutes, etc.), the region may be designated as an AOI. The thresholds mentioned above may be default settings of the online to offline service system 100, or may be adjustable under different situations. For example, for a city, the area threshold may be relatively small for an ordinary person in the art, whereas for a village, the area threshold may be relatively large for an ordinary person in the art. In some embodiments, the AOI may represent a polygonal geographical entity in map data. The polygonal geographical entity may be a residential district, a hospital, a university, a shopping mall, a scenic spot, or any other entity that can be collectively described by one name. In some embodiments, the term “AOI” may refers to information associated with an AOI, such as an AOI name, an AOI location (e.g., a location name), coordinate ranges, an AOI contour, or the like, or any combination thereof. The AOI contour may be a boundary of the AOI.

As used herein, a POI associated with an AOI may refer to that the POI is the AOI, or the POI is located within the AOI geographically. The POI being the AOI may refer to that one or more region parameters of the POI satisfy a criterion of the AOI. For example, if a region parameter (e.g., an area of the region, a largest distance between two points on a boundary of the region, an average travel time (e.g., an average walking time) between the two points) of the POI is greater than a threshold, the POI may be designated as the AOI. A POI located within an AOI may refer to that the location of the POI is within a geographical scope of the AOI.

In some embodiments, the processing device 112 may determine whether the initial POI is associated with the AOI by determining whether the initial POI is the AOI. In some embodiments, the processing device 112 may determine whether the initial POI is the AOI based on the attribute information of the initial POI, such as a name or location name of the initial POI, one or more region parameters (e.g., an area of the region, a largest distance between two points on a boundary of the region, an average travel time (e.g., an average walking time) between the two points) of the initial POI. For example, if a region area of the initial POI is greater than an area threshold (e.g., 1 km², 5 km², 10 km², 20 km²), the processing device 112 may determine that the initial POI is the AOI. As another example, it is assumed that the initial POI is a rectangle region and a diagonal distance of the region of the initial POI is larger than a distance threshold (e.g., 1 km, 2 km, 5 km, 10 km), the processing device 112 may determine that the initial POI is the AOI. As a further example, it is assumed that the initial POI is a rectangle region and an average walking time along a diagonal line of the region of the initial POI is greater than a time threshold (e.g., 10 minutes, 20 minutes, 30 minutes), the processing device 112 may determine that the initial POI is the AOI.

In some embodiments, the processing device 112 may determine whether the initial POI is associated with the AOI by determining whether the initial POI is located within the AOI, geographically. In some embodiments, the processing device 112 may identify one or more AOIs from an AOI database based on information (e.g., a name, a location name) of the initial POI. For example, if the name of the initial POI is “Oak Bay District Supermarket”, the processing device 112 may determine the one or more AOIs including “Oak Bay District”, “Oak Bay Primary School”, “Oak Bay Park”, etc. Then the processing device 112 may determine whether the initial POI is located geographically within one of the one or more AOIs based on the location of the initial POI and the geographical scope of the one of the one or more AOIs. In some embodiments, the processing device 112 may determine whether the initial POI is located within one of the one or more AOIs based on a distance between the initial POI and each of the one or more AOIs. For example, if the initial POI is located within a threshold distance from a specific AOI center, the processing device 112 may determine the initial POI is located within the specific AOI. The specific AOI center may denote a location located in the geographical scope of the AOI. As another example, if a shortest distance from the initial POI to the specific AOI boundary is less than a threshold, the processing device 112 may determine the initial POI is located within the specific AOI.

In some embodiments, the processing device 112 may determine whether the initial POI is associated with the AOI based on a name and/or location name of the initial POI. For example, the processing device 112 may compare the name and/or location name of the initial POI with a name and/or location name of each of a plurality of AOIs stored in an AOI database. The processing device 112 may determine whether the initial POI is the AOI based on a similarity between the name of the initial POI and the name of each of the plurality of AOIs and/or a similarity between the location name of the initial POI and the location name of each of the plurality of AOIs. If the similarity between the name of the initial POI and the name of one of the plurality of AOIs and/or the similarity between the location name of the initial POI and the location name of the one of the plurality of AOIs is greater than a threshold, the processing device 112 may determine that the initial POI is associated with the AOI. Merely for an example, if the name of the initial POI is “Oriental Pearl Tower Station”, the name of one of the plurality of AOIs is “Oriental Pearl Tower Station”, and a similarity between the name of the initial POI “Oriental Pearl Tower Station” and the name of one of the plurality of AOIs “Oriental Pearl Tower Station” is 100%, the processing device 112 may determine that the initial POI is associated with the AOI in response to determine that the similarity 100% is greater than a threshold (e.g., 80%). If the name of the initial POI is “Oriental Pearl Tower Station Entrance A”, the name of one of the plurality of AOIs is “Oriental Pearl Tower Station”, a similarity between the name of the initial POI “Oriental Pearl Tower Station” and the name of one of the plurality of AOIs “Oriental Pearl Tower Station” is 90%, the processing device 112 may determine that the initial POI is associated with the AOI in response to determine that the similarity 90% is greater than a threshold (e.g., 80%). As another example, if a word count of identical words in the name of the initial POI and the name of one of the plurality of AOIs is greater than a threshold, the processing device 112 may determine that the initial POI is associated with the AOI. As still another example, the processing device 112 may determine whether the name and/or the location name of the initial POI includes a specializing portion (e.g., a key term). If the name and/or the location name of the initial POI does not include the specializing portion (e.g., a key term), the processing device 112 may determine the initial POI is associated with the AOI. The specializing portion may include “Entrance A”, “Entrance B”, “East Gate”, “Northwest Gate”, “Building A”, “Exit one”, or the like, or any combination thereof. For example, if the name of the initial POI is “Oriental Pearl Tower Station Entrance A”, the specializing portion of the name of the initial POI is “Entrance A”. The processing device 112 may determine that the initial POI “Oriental Pearl Tower Station Entrance A” is not the AOI. If the name of the initial POI is “Oriental Pearl Tower Station”, the initial POI “Oriental Pearl Tower Station” does not include the specializing portion. The processing device 112 may determine that the initial POI “Oriental Pearl Tower Station” is the AOI. The specializing portions may be default settings of the online to offline service system 100, or may be adjustable under different situations.

In 530, the processing device 112 (e.g., the determination module 420) may generate a planar area for describing the AOI. In some embodiments, the planar area may be used to enclose and describe a geographical scope of the AOI. The planar area may be an area of any shape, such as, a triangle, a quadrangle, a pentagon, a circle, an ellipse, etc. In some embodiments, the shape of the planar area may be the same as or similar to the shape of the AOI contour. For example, the shape of the planar area is matched with the AOI contour. A boundary of the planar area may denote a rough contour of the AOI. An area of the planar area may denote an area of the AOI. As another example, the planar area may be larger than the AOI contour. In some embodiments, the planar area may be a minimum bounding box that has a preset shape (e.g., a rectangle, a square, a polygon, a circle, an ellipse) and encloses the AOI on the map.

In some embodiments, the processing device 112 may determine the planar area by determining the AOI associated with the initial POI. For example, the processing device 112 may designate a region of the AOI as the planar area. As another example, the processing device 112 may designate a region covering the region of the AOI as the planar area. The processing device 112 may determine the AOI associated with the initial POI based on the initial POI. In response to determine that the initial POI is the AOI, the processing device 112 may designate the information of the initial POI as the information of the AOI. In response to determine that the initial POI is located within the AOI geographically, the processing device 112 may determine the AOI based on the initial POI as described in operation 520. For example, the processing device 112 may identify one or more AOIs from an AOI database based on the information of the initial POI. As a further example, the processing device 112 may identify the one or more AOIs from the AOI database based on the name of the initial POI.

The planar area may include one or more candidate POIs. A candidate POI may include information associated with the candidate POI, such as a candidate POI name, an address of the candidate POI, coordinates of the candidate POI (e.g., the longitude and/or latitude), etc. In some embodiments, the one or more candidate POIs may include the initial POI. In some embodiments, a candidate POI may be a specific location within the AOI, such as an entrance/exit, a shop, a station, or the like, or any other places. In some embodiments, the processing device 112 may determine the one or more candidate POIs based on the AOI. For example, the processing device 112 may determine the one or more candidate POIs within the AOI boundary or within a distance threshold from the AOI boundary (or the AOI center). As used herein, a candidate POI may refer to a region or point associated with one or more region parameters (e.g., an area of the region, a largest distance between two points on a boundary of the region, an average travel time (e.g., an average walking time) between the two points) smaller than a threshold as described above.

In 540, the processing device 112 (e.g., the determination module 420) may determine a recommended POI from the one or more candidate POIs based on at least one of the initial POI or a current location of the user. The recommended POI may be a pickup location of an order associated with the user, a destination of the user, etc. In some embodiments, the current location may refer to a geographic location of the user. The geographic location of the user may be obtained by a positioning device associated with the user. For example, the positioning device may include an on-board device of the vehicle, a positioning chip installed in a mobile terminal associated with the user (e.g., the requester terminal 130, the provider terminal 140, or the mobile device 300 shown in FIG. 3).

In some embodiments, the processing device 112 may determine one of the one or more candidate POIs as the recommended POI based on a location relationship between the initial POI and/or the current location of the user and each of the one or more candidate POIs. For example, the processing device 112 may determine a specific POI among the one or more candidate POIs that is closest to the initial POI and/or the current location of the user as the recommended POI. As another example, the processing device 112 may determine a specific POI among the one or more candidate POIs corresponding to a shortest travel time from the initial POI and/or the current location of the user to the specific POI as the recommended POI.

In some embodiments, the processing device 112 may determine one of the one or more candidate POIs as the recommended POI based on a hotness of each of the one or more candidate POIs. As used herein, the hotness of a POI may refer to a frequency of the POI as a destination and/or a starting location in a region including the POI during a time period. The greater the frequency of the POI as a destination and/or a starting location in the region is, the larger the hotness of the POI may be. For example, the processing device 112 may determine a hottest POI in a past period of time (e.g., a day, a week, a month, etc.) from the one or more candidate POIs as the recommended POI. As a further example, in a taxi hailing service system, the processing device 112 may determine a POI that most people use among the one or more candidate POIs as a pick-up location as the recommended POI. In some embodiments, the processing device 112 may determine the recommended POI from the one or more candidate POIs based on user's historical records in a past period of time (e.g., a day, a week, a month, etc.). For example, the processing device 112 may determine a specific POI among the one or more candidate POIs that the user has searched or queried as the recommended POI. As another example, the processing device 112 may determine a specific POI among the one or more candidate POIs that the user uses as a starting location or pickup location as the recommended POI.

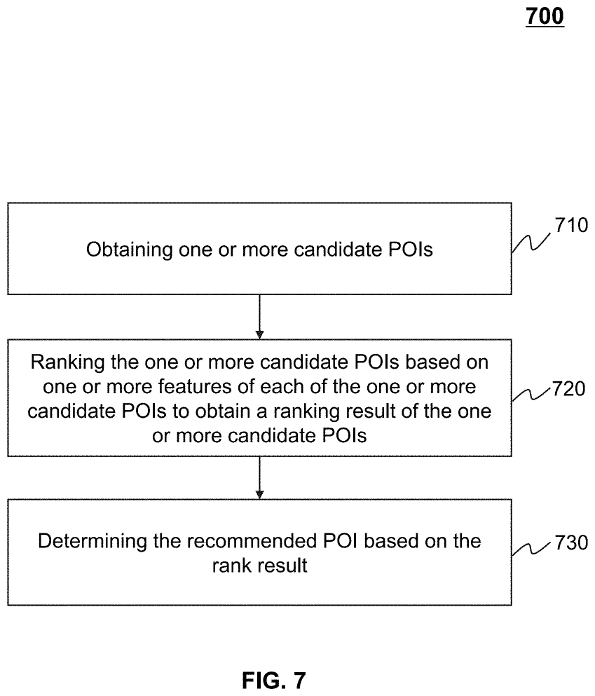

In some embodiments, the processing device 112 may determine the recommended POI based on a ranking result of the one or more candidate POIs. For example, the processing device 112 may rank the one or more candidate POIs according to one or more features of each of the one or more candidate POIs to obtain the ranking result of the of the one or more candidate POIs. The processing device 112 may determine the candidate POI ranked first (i.e., TOP 1) in the ranking result as the recommended POI. In some embodiments, the one or more features of each of the one or more candidate POIs may include a hotness of each of the one or more candidate POIs, a distance between the initial POI and the each of the one or more candidate POIs, a distance between the current location of the user and the each of the one or more candidate POIs, or the like, or any combination thereof. In some embodiments, the processing device 112 may rank the one or more candidate POIs using a ranking model, such as a RankNet model, a LambdaRank model, a LambdaMART model, etc. For example, the processing device 112 may input the one or more candidate POIs and the corresponding features of each of the one or more candidate POIs into the ranking model to determine the ranking result. In some embodiments, the ranking model may be constructed based on a machine learning model. The machine learning model may include a random forest of decision tree, a boosted decision tree, a gradient boosted decision tree, or the like, or any combination thereof. More descriptions for determining the recommended POI from the one or more candidate POIs may be found in FIG. 7 and the description thereof.

In 550, the processing device 112 (e.g., the displaying module 430) may display the planar area with the recommended POI to the user. In some embodiments, the processing device 112 may display the planar area with the recommended POI on a client terminal (e.g., the requester terminal 130, the provider terminal 140, or the display 320 shown in FIG. 3) of the user. In some embodiments, the processing device 112 may display the planar area on the map for highlighting the AOI, such that the AOI may be distinguished from other regions on the map. In some embodiments, the planar area may be clearly displayed on a display (e.g., the display 320) while other regions in the map may be displayed more ambiguously. In other words, a definition of the AOI may be higher than other regions on the map. In some embodiments, the color of the planar area may be different from the color of other regions of the map. For example, the color of the planar area may be darker than that of the other regions on the map. As another example, the color of the planar area may be blue while the color of other regions of the map may be green.

In some embodiments, the processing device 112 may mark a location of the recommended POI on the planar area of the AOI using an identifier. In some embodiments, the identifier may be an image, a graphic logo (e.g., a pin), a miniature of the recommended POI, etc. For example, the identifier may be denoted as a spot, a geometric circle, a geometric square, or any visual shape that uniquely identifies the location of the recommended POI. In some embodiments, the processing device 112 may display the information (e.g., the name, the address, coordinates (e.g., a longitude and/or a latitude), etc.) of the recommended POI next to the identifier.

In some embodiments, the processing device 112 may display the current location of the user on the map using another identifier. The identifier of the current location and the identifier of the recommended POI may be same or different. For example, the identifier of the recommended POI may be a pin and the identifier of the current location may be a spot. As another example, the identifier of the recommended POI and the identifier of the current location may be both a pin, while the colors of the identifier of the recommended POI and the identifier of the current location may be different. Further, the processing device 112 may display a location and/or direction relationship between the current location of the user and the recommended POI on the map. For example, the processing device 112 may determine a line (e.g., a dotted line or a dashed line) connecting the current location of the user and the recommended POI on the map. In some embodiments, the line connecting the current location of the user and the recommended POI may include an arrow pointing from the current location of the user to the recommended POI. Further, the processing device 112 may display direction information between the current location of the user and the recommended POI.

In some embodiments, the processing device 112 may determine and/or display a route with the recommended POI as a destination and the current location of the user as a starting location on the map in response to determine the recommended POI. In some embodiments, the processing device 112 may determine and/or display a route with the recommended POI as a destination and the current location of the user as a starting location in response to the receipt of a signal indicating that the user accepts the recommended POI. In some embodiments, the route may be a walking navigation path with a nearest distance and/or a shortest travel time between the destination (i.e., the recommended POI) and the current location of the user. In some embodiments, the processing device 112 may display information associated with the route between the recommended POI and the current location to the user. For example, the information associated with the route may include a travel distance along the route, a travel duration of the route, an estimated time for arriving the recommended POI, etc.

In some embodiments, the processing device 112 may display one or more reference POIs close to the recommended POI and/or the current location of the user on the map to help the user to identify the recommended POI and/or the current location of the user. In some embodiments, the one or more reference POIs may be easier to identify for the user. For example, the reference POIs may include a landmark building (e.g., a provincial library, a museum, etc.), a square, a lake, a river, etc.

In some embodiments, the location of the identifier of the recommended POI may be changed. For example, the user may move or drag the map to change the location that the identifier of the recommended POI points to. Then the location of the recommended POI may be corrected to obtain a corrected POI. As another example, the user may directly move the identifier of the recommended POI to change the location that the moved identifier points to. Then the location of the recommended POI may be corrected to obtain a corrected POI. In response to the receipt of a signal indicating that the user moves the identifier or the map, the processing device 112 may determine the corrected POI based on a location that the moved identifier points to. The processing device 112 may generate a route with the corrected POI as the destination and the current location of the user as the starting location; and display the route on the map.

In 560, the processing device 112 (e.g., the determination module 420) may generate the recommended POI based on at least one of the initial POI or the current location of the user. In some embodiments, the processing device 112 may designate the initial POI or the current location of the user as the recommended POI. In some embodiments, the processing device 112 may determine one or more candidate POIs based on at least one of the initial POI or the current location of the user. For example, the processing device 112 may identify one or more candidate POIs from a POI database based on information of the initial POI and/or the current location of the user. As another example, the processing device 112 may identify one or more candidate POIs located within a threshold distance (e.g., 1 km, 2 km, 5 km, 10 km, etc.) from the initial POI or the current location of the user. Then the processing device 112 may identify the recommended POI from the one or more candidate POIs. More descriptions for determining the recommended POI from the one or more candidate POIs may be as described in connection with operation 540 in FIG. 5 and the descriptions thereof.

In 570, the processing device 112 (e.g., the displaying module 430) may display the recommended POI to the user. In some embodiments, the processing device 112 may direct a client terminal (e.g., the requester terminal 130, the provider terminal 140, or the display 320 shown in FIG. 3) of the user to display the recommended POI. In some embodiments, the processing device 112 may mark the location of the recommended POI using an identifier, such as a pin, etc. In some embodiments, the processing device 112 may display information (e.g., the name, the address, the longitude, and/or the latitude, etc.) of the recommended POI next to the identifier. In some embodiments, the processing device 112 may display a location relationship between the current location of the user and the recommended POI on the map. For example, the processing device 112 may determine a line (e.g., a dotted line or a dashed line) connecting the current location of the user and the recommended POI on the map. In some embodiments, the processing device 112 may determine and/or display a route with the recommended POI as a destination and the current location of the user as a starting location on the map. The route may be a waling navigation path with a nearest distance and/or a shortest travel time between the destination (i.e., the recommended POI) and the current location of the user.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, the operation 540 and the operation 550 may be combined into a single operation to display the planar area with the recommended POI. As another example, in operation 510, if the user inputs the initial POI via a voice, the processing device 112 may also pre-convert the voice into a text file.

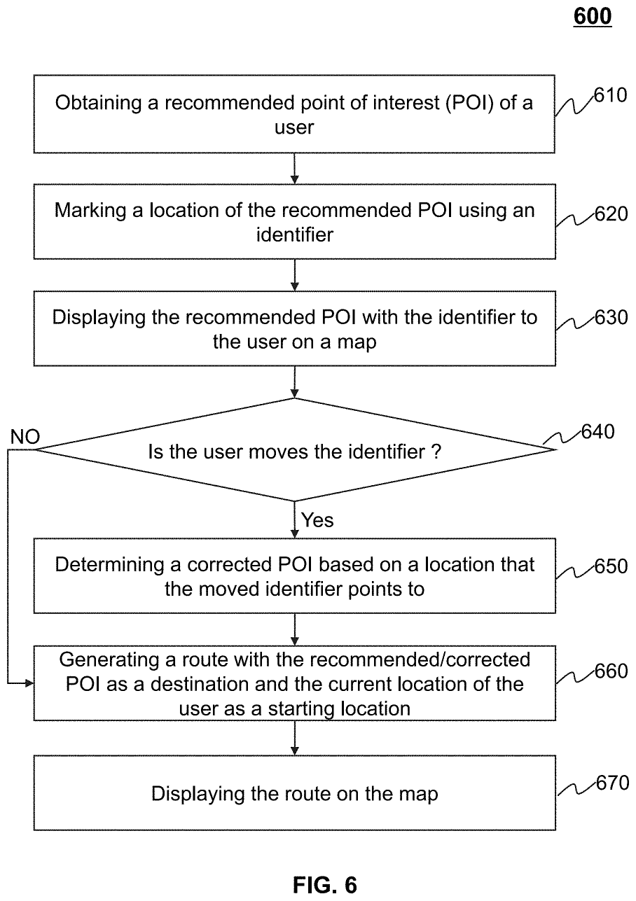

FIG. 6 is a schematic flowchart illustrating an exemplary process for point of interest (POI) recommendation and display according to some embodiments of the present disclosure. In some embodiments, the process 600 may be implemented as a set of instructions (e.g., an application) stored in the storage device 150, ROM 230 or RAM 240, or storage 390. The processing device 112, the processor 220, and/or the CPU 340 may execute the set of instructions, and when executing the instructions, the processing device 112, the processor 220, and/or the CPU 340 may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process 600 illustrated in FIG. 6 and described below is not intended to be limiting.

In 610, the processing device 112 (e.g., the obtaining module 410) may obtain a recommended point of interest (POI) of a user. The recommended POI of the user may be determined from one or more candidate POIs based on at least one of the initial POI or a current location of the user as described in connection with operations 540 and 560 as illustrated in FIG. 5.

In 620, the processing device 112 (e.g., the determination module 420) may mark a location of the recommended POI using an identifier. The identifier may denote a rough location of the recommended POI. In some embodiments, the identifier may be an image, a graphic logo (e.g., a pin), a miniature of the recommended POI, etc. For exemplary, the identifier may be denoted as a spot, a geometric circle, a geometric square, or any visual shape that uniquely identifies the location of the recommended POI. In some embodiments, the processing device 112 may attach the identifier to the location of the recommended POI on a map based on location information of the recommended POI. The location information of the recommended POI may include coordinates (e.g., the latitude and/or longitude), an address, or the like, or any combination thereof.

In 630, the processing device 112 (e.g., the displaying module 430) may display the recommended POI with the identifier to the user on a map. In some embodiments, the processing device 112 may direct a client terminal (e.g., the requester terminal 130 and/or the provider terminal 140) of the user to display the recommended POI with the identifier to the user on the map. In some embodiments, the processing device 112 may display information (e.g., the name, the address, coordinates (e.g., a longitude and/or a latitude), etc.) of the recommended POI next to the identifier. In some embodiments, the processing device 112 may display the recommended POI with the identifier to the user on the map for helping the user to know the location of the recommended POI on the map and a relationship between the current location of the user and the recommended POI quickly and accurately.

In 640, the processing device 112 (e.g., the determination module 420) may determine whether the user moves the identifier. In some embodiments, when the recommended POI is displayed on the map, the processing device 112 may begin timing. In response to a determination that the user is not performing any operations on the map and/or the identifier of the recommended POI within a duration threshold (e.g., a constant, 0.1 s, 0.2 s, 0.3 s, etc.), the processing device 112 may determine that the user does not move the identifier and receive the recommended POI. In some embodiments, the processing device 112 may determine whether the user moves the identifier based on an operation of the user on a display of the client terminal (e.g., the requester terminal 130 and/or the provider terminal 140). For example, the processing device 112 may determine that the user moves the identifier in response to receive an operation signal for moving the map. As another example, the processing device 112 may determine that the user moves the identifier of the recommended POI in response to receive an operation signal for moving the identifier, directly. In some embodiments, the operation of the user on the display of the client terminal may include dragging or moving the map and/or the identifier, pressing or clicking one or more buttons (e.g., a button for up, a button for down, a button for left, a button for right, etc.) that can be used to move the map and/or the identifier, or the like, or any combination thereof.

In response to a determination that the user moves the identifier, the processing device 112 may determine that the user does not receive the recommended POI. In response to a determination that the user does not move the identifier, the processing device 112 may determine that the user receives the recommended POI. In response to a determination that the user moves the identifier, the processing device 112 may proceed to perform operation 650. In response to a determination that the user does not move the identifier, the processing device 112 may proceed to perform operation 660.

In 650, the processing device 112 (e.g., the determination module 420) may determine a corrected POI based on a location that the moved identifier points to. In some embodiments, the processing device 112 may designate the location that the moved identifier points to as the location of the correction POI. In some embodiments, the processing device 112 may determine a plurality of candidate POIs based on the location that the moved identifier points to. For example, the processing device 112 may identify the plurality of candidate POIs from a POI database based on information of the location that the moved identifier points to. The information of the location that the moved identifier points to may include the coordinates (e.g., a longitude and/or a latitude), a name, an address, etc. As another example, the processing device 112 may identify the plurality of candidate POIs within a threshold distance (e.g., 1 km, 2 km, 5 km, 10 km, etc.) from the location that the moved identifier points to. The plurality of candidate POIs may be the same as or different from the one or more candidate POIs described elsewhere in the present disclosure (e.g., operation 530 illustrated in FIG. 5). For example, the plurality of candidate POIs and the one of the one or more candidate POIs described elsewhere in the present disclosure only have one identical POI. As another example, the plurality of candidate POIs and the one of the one or more candidate POIs described elsewhere in the present disclosure do not have identical POI. In some embodiments, the processing device 112 may determine the corrected POI from the plurality of candidate POIs based on the location that the moved identifier points to. For example, the processing device 112 may determine one of the plurality of candidate POIs that is closest to the location that the moved identifier points to as the corrected POI. In some embodiments, the processing device 112 may determine a hottest POI in a past period of time (e.g., a day, a week, a month, etc.) from the plurality of candidate POIs as the corrected POI. More descriptions about hotness of a POI may be found elsewhere in the present disclosure (e.g., operation 540 illustrated in FIG. 5). In some embodiments, the processing device 112 may display the information (e.g., the name, the address, the longitude, and/or the latitude, etc.) of the corrected POI next to the moved identifier.

In 660, the processing device 112 (e.g., the determination module 420) may generate a route with the recommended POI or corrected POI as a destination and the current location of the user as a starting location. In some embodiments, the route may be a straight line between the destination and the starting location. In some embodiments, the route may be a walking navigation path with a nearest distance or shortest travel time between the destination and the current location of the user. In some embodiments, the processing device 112 may update the route from time to time based on the current location of the user when the user travels to the recommended POI. In some embodiments, the processing device 112 may determine an estimated time of arrival (ETA) of the user arriving the recommended POI based on the destination (i.e., the recommended POI) and the starting location (i.e., the current location of the user). In some embodiments, the processing device 112 may update the ETA in real time based on the current location of the user.

In 670, the processing device 112 (e.g., the displaying module 430) may display the route on the map. In some embodiments, the processing device 112 may mark the route with a dashed line, a solid line, an arrow, or the like, or any other token that highlights the route. In some embodiments, the processing device 112 may mark the route with a color that is different from the rest of the map. For example, the color of the route is red while the color of the rest of the map is blue.

In some embodiments, the processing device 112 may display the ETA on the map. In some embodiments, the processing device 112 may display one or more reference POIs close to the destination (i.e., the recommended POI) and/or the starting location (i.e., the current location of the user) on the map to help the user to identify the location of the destination (i.e., the recommended POI) and/or the starting location (i.e., the current location of the user). In some embodiments, the one or more reference POIs may be easier to identify from the map, or the one or more reference POIs may be well-known location, or the one or more reference POIs may be easier to be found or seen by the user at the current location, etc. For example, the reference POI may be a landmark building (e.g., a provincial library, a museum, etc.), a square, a lake, a river, etc. In some embodiments, the processing device 112 may direct the client terminal (e.g., the requester terminal 130 or the provider terminal 140) of the user to display the map with the route to the user.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, the operation 620 and the operation 630 may be combined into a single operation to display the recommended POI with an identifier to the user on a map. As another example, in operation 610, the processing device 112 may also obtain one or more candidate POIs.

FIG. 7 is a schematic flowchart illustrating an exemplary process for determining a recommended POI according to some embodiments of the present disclosure. In some embodiments, the process 700 may be implemented as a set of instructions (e.g., an application) stored in the storage device 150, ROM 230 or RAM 240, or storage 390. The processing device 112, the processor 220 and/or the CPU 340 may execute the set of instructions, and when executing the instructions, the processing device 112, the processor 220 and/or the CPU 340 may be configured to perform the process 700. The operations of the illustrated process presented below are intended to be illustrative. In some embodiments, the process 700 may be accomplished with one or more additional operations not described and/or without one or more of the operations discussed. Additionally, the order in which the operations of the process 700 illustrated in FIG. 7 and described below is not intended to be limiting. Operation 540 may be performed according to process 700 as described in FIG. 7.

In 710, the processing device 112 (e.g., the determination module 420) may obtain one or more candidate POIs. The one or more candidate POIs may be determined based on an initial POI and/or a current location of a user as described in connection with operations 520-530 as illustrated in FIG. 5.

In 720, the processing device 112 (e.g., the determination module 420) may rank the one or more candidate POIs based on one or more features of each of the one or more candidate POIs to obtain a ranking result of the one or more candidate POIs. In some embodiments, the ranking result of the one or more candidate POIs may include a ranking list. The ranking list may include a ranking of each of the one or more candidate POIs. For example, the ranking list may include a number (e.g., 1, 2, 3, etc.) representing the ranking of each of the one or more candidate POIs. In some embodiments, the ranking result may include a score of the correlation between each of the one or more candidate POIs and a related POI (e.g., the initial POI or the current location of the user as described in FIG. 5). In some embodiments, the one or more features of each of the one or more candidate POIs may include a hotness of each of the one or more candidate POIs, a distance between the initial POI and the each of the one or more candidate POIs, a distance between the current location of the user and the each of the one or more candidate POIs, or the like, or any combination thereof.

In some embodiments, the processing device 112 may obtain the ranking result by using a trained machine learning model (i.e., a ranking model), such as a RankNet model, a LambdaRank model, or a LambdaMART model, etc. For example, the processing device 112 may designate the one or more features of each of the one or more candidate POIs as a feature vector. The processing device 112 may determine the ranking result by inputting the feature vector corresponding to each of the one or more candidate POIs into the trained machine learning model.

In some embodiments, the trained machine learning model may be constructed based on a machine learning model. For example, the trained machine learning model may be obtained by training the machine learning model using a plurality of groups of training data. In some embodiments, the machine learning model may include a random forest of decision tree, a boosted decision tree, a gradient boosted decision tree, or the like, or any combination thereof. Each of the plurality of groups of training data may include one or more features of each of multiple POIs and an actual ranking result of the multiple POIs. The one or more features of each of the multiple POIs may be designated as an input of the machine learning model and the actual ranking result of the multiple POIs may be designate as a desired output of the machine learning model in a training process to determine the trained machine learning model. The trained machine learning model may rank the inputted candidate POIs based on calculated/determined feature values for the one or more features of each of the one or more candidate POIs.

In some embodiments, the trained machine learning model may be obtained by performing a plurality of iterations. For each of the plurality of iterations, a specific group of training data may first be inputted into the machine learning model. The machine learning model may extract the one or more features corresponding to each of the multiple POIs in the specific group of training data. Based on the extracted features, the machine learning model may determine a predicted ranking result corresponding to each of the multiple POIs in the specific group of training data. The predicted ranking result may then be compared with a desired ranking result (i.e., the actual ranking result) corresponding to each of the multiple POIs in the specific group of training data based on a cost function. The cost function of the machine learning model may be configured to assess a difference between an estimated value (e.g., the predicted ranking result) of the machine learning model and a desired value (e.g., the actual ranking result). If the value of the cost function exceeds a threshold in a current iteration, parameters of the machine learning model may be adjusted and updated to cause the value of the cost function (i.e., the difference between the predict ranking result and the actual ranking result) smaller than the threshold. Accordingly, in a next iteration, another group of training data may be inputted into the machine learning model to train the machine learning model as described above. Then the plurality of iterations may be performed to update the parameters of the machine learning model until a terminated condition is satisfied. The terminated condition may provide an indication of whether the machine learning model is sufficiently trained. For example, the terminated condition may be satisfied if the value of the cost function associated with the machine learning model is minimal or smaller than a threshold (e.g., a constant). As another example, the terminated condition may be satisfied if the value of the cost function converges. The convergence may be deemed to have occurred if the variation of the values of the cost function in two or more consecutive iterations is smaller than a threshold (e.g., a constant). As still an example, the terminated condition may be satisfied when a specified number of iterations are performed in the training process. The trained machine learning model may be determined based on the updated parameters. In some embodiments, the trained machine learning model (i.e., the ranking model) may be transmitted to the storage device 150, or any other storage device for storage.

In 730, the processing device 112 (e.g., the determination module 420) may determine the recommended POI based on the rank result. In some embodiments, the processing device 112 may determine the candidate POI ranked first (i.e. TOP 1) in the ranking result as the recommended POI. In some embodiments, the processing device 112 may determine the candidate POI with a highest score in the ranking result as the recommended POI.

In some embodiments, the processing device 112 may transmit the recommended POI to a client terminal (e.g., the requester terminal 130 or the provider terminal 140) of the user and direct the client terminal to display the recommended POI. In some embodiments, the processing device 112 may attach an identifier (e.g., a pin) on the map to help the user to identify the recommended POI. In some embodiments, the processing device 112 may determine the TOP N (e.g., TOP 2, TOP 3, TOP 4, etc.) other than the TOP 1 as one or more candidate recommended POIs. In some embodiments, the processing device 112 may mark the one or more candidate recommended POIs with identifiers that are different from the identifier attached on the map. For example, the identifier representing the recommended POI attached on the map is a pin, while the identifiers representing the one or more candidate recommended POIs attached on the map are green dots.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, the operation 710 and the operation 720 may be combined into a single operation to obtain an initial POI and corresponding candidate POIs. As another example, in 740, the processing device 112 may also display the recommended POI to the user.

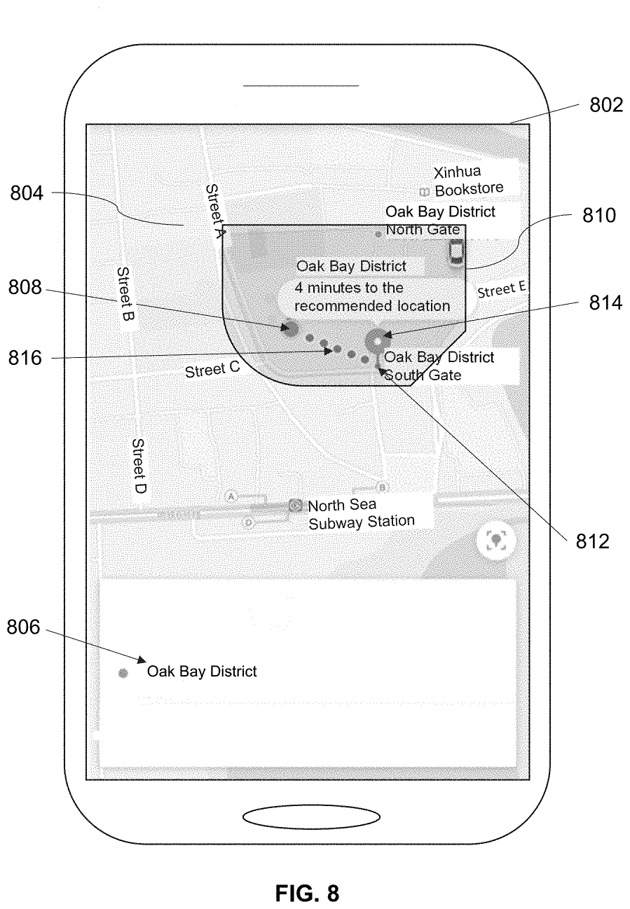

FIG. 8 is a schematic diagram illustrating an exemplary user display interface of a client terminal according to some embodiments of the present disclosure. Once the initial POI 806 input by an user is determined to be an AOI, display 802 shows a planar area 810 describing the AOI thereon, as shown in FIG. 8. For example, when a user input “Oak Bay District” as the initial POI 806, the processing device 112 may determine that the “Oak Bay District” is an AOI. Then the planar area 810 describing “Oak Bay District” is displayed prominently with a different color on a map 804. A dot 808 on the map 804 denotes a current location of the user. A dot 812 marked by a pin 814 (i.e., an identifier) denotes the location of a recommended POI “Oak Bay District South Gate”. A dashed line 816 indicates a route between the current location of the user and the recommended POI 812 (i.e., “Oak Bay District South Gate”). The user may know the relationship between the current location 808 of the user and the recommended POI 812 on the map 804 more quickly and accurately based on the dashed line 816. The travel time from the current location to the recommended location 812 is displayed on the map. The user may find the recommended POI more easily by walking along the dashed line 816. For purposes of the present disclosure, the current location of the user (e.g., a passenger) is used interchangeably with the location of the user's terminal device, as the user almost always carries the terminal device when requesting hailing service. However, one skilled in the art will understand that when the user and the terminal device are separated by a far distance in the unlikely event, all position information will refer to that of the terminal device.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer readable program code embodied thereon.

A non-transitory computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran, Perl, COBOL, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system for point of interest (POI) recommendation, comprising:
at least one storage medium including a set of instructions;
at least one processor in communication with the at least one storage medium, wherein when executing the set of instructions, the at least one processor is directed to cause the system to perform operations including:
obtaining an initial point of interest (POI) of a user;
determining whether the initial POI is an area of interest (AOI); and
in response to a determination that the initial POI is the AOI,
generating a planar area describing the AOI, the planar area including one or more candidate POIs;
determining, based at least on one of the initial POI or a current location of the user, a recommended POI from the one or more candidate POIs; and
displaying the planar area with the recommended POI to the user.

2. The system of claim 1, wherein to display the planar area with the recommended POI to the user, the at least one processor is directed to cause the system to perform operations including:
marking a location of the recommended POI on the planar area of the AOI using an identifier; and
directing a client terminal of the user to display the planar area of the AOI with the identifier to the user on a map.

3. The system of claim 2, wherein the at least one processor is directed to cause the system to perform additional operations including:
in response to receipt of a signal indicating that the user accepts the recommended POI, generating a route with the recommended POI as a destination and the current location of the user as a starting location; and
displaying the route on the map.

4. The system of claim 2, wherein to the at least one processor is directed to cause the system to perform operations including:
in response to receipt of a signal indicating that the user moves the identifier, determining a corrected POI based on a location that the moved identifier points to;
generating a route with the corrected POI as the destination and the current location of the user as the starting location; and
displaying the route on the map.

5. The system of claim 3, wherein the route is a walking navigation path with a nearest distance between the destination and the current location of the user.

6. The system of claim 3, wherein the at least one processor is directed to cause the system to perform additional operations including:
displaying one or more reference POIs close to the destination on the map to help the user to identify the location of the destination.

7. The system of claim 1, wherein to determine, based at least on one of the initial POI or the current location of the user, the recommended POI from the one or more candidate POIs, the at least one processor is directed to cause the system to perform additional operations including:
ranking, based on one or more features of each of the one or more candidate POIs, the one or more candidate POIs to obtain a ranking result of the one or more candidate POIs; and
determining the recommended POI based on the ranking result.

8. The system of claim 7, wherein the ranking of the one or more candidate POIs is performed using a LambdaMART model.

9. The system of claim 7, wherein the one or more features of each of the one or more candidate POIs includes at least one of:
a hotness of each of the one or more candidate POIs;
a distance between the initial POI and the each of the one or more candidate POIs; or
a distance between the current location of the user and the each of the one or more candidate POIs.

10. The system of claim 1, wherein to obtain an initial point of interest (POI) of a user, the at least one processor is further directed to cause the system to perform additional operations including:
in response to an operation instruction to move a map by the user, determining the initial POI.

11. The system of claim 1, wherein the at least one processor is further directed to cause the system to perform additional operations including:
in response to a determination that the initial POI is not the AOI,
generating the recommended POI based on at least one of the initial POI or the current location of the user; and
displaying the recommended POI to the user.

12. A method for point of interest (POI) recommendation, comprising:
obtaining an initial point of interest (POI) of a user;
determining whether the initial POI is an area of interest (AOI); and
in response to a determination that the initial POI is the AOI,
generating a planar area describing the AOI, the planar area including one or more candidate POIs;
determining, based at least on one of the initial POI or a current location of the user, a recommended POI from the one or more candidate POIs; and
displaying the planar area with the recommended POI to the user.

13. The method of claim 12, wherein the displaying the planar area with the recommended POI to the user includes:
marking a location of the recommended POI on the planar area of the AOI using an identifier; and
directing a client terminal of the user to display the planar area of the AOI with the identifier to the user on a map.

14. The method of claim 13, the method further comprising:
in response to receipt of a signal indicating that the user accepts the recommended POI, generating a route with the recommended POI as a destination and the current location of the user as a starting location; and
displaying the route on the map.

15. The method of claim 13, the method further comprising:
in response to receipt of a signal indicating that the user moves the identifier, determining a corrected POI based on a location that the moved identifier points to;
generating a route with the corrected POI as the destination and the current location of the user as the starting location; and
displaying the route on the map.

16. The method of claim 14, wherein the route is a walking navigation path with a nearest distance between the destination and the current location of the user.

17. The method of claim 14, wherein the method further comprising:
displaying one or more reference POIs close to the destination on the map to help the user to identify the location of the destination.

18. The method of claim 12, wherein the determining, based at least on one of the initial POI or the current location of the user, the recommended POI from the one or more candidate POIs includes:
ranking, based on one or more features of each of the one or more candidate POIs, the one or more candidate POIs to obtain a ranking result of the one or more candidate POIs; and
determining the recommended POI based on the ranking result.

19. (canceled)

20. The method of claim 18, wherein the one or more features of each of the one or more candidate POIs includes at least one of:
a hotness of each of the one or more candidate POIs;
a distance between the initial POI and the each of the one or more candidate POIs; or
a distance between the current location of the user and the each of the one or more candidate POIs.

21-23. (canceled)

24. A non-transitory computer readable medium, comprising a set of instructions, wherein when executed by at least one processor, the set of instructions direct the at least one processor to perform acts of:
obtaining an initial point of interest (POI) of a user;
determining whether the initial POI is an area of interest (AOI); and
in response to a determination that the initial POI is the AOI,
generating a planar area describing the AOI, the planar area including one or more candidate POIs;
determining, based at least on one of the initial POI or a current location of the user, a recommended POI from the one or more candidate POIs; and
displaying the planar area with the recommended POI to the user.
